(19) United States
(12) Patent Application Publication
(10) Pub. No.: US 2020/0104792 A1
(43) Pub. Date: Apr. 2, 2020

(54) SECURE PAYMENT SYSTEM AND METHOD FOR COURIER BASED TRANSACTIONS

(71) Applicant: GLOVOAPP23 SL, Barcelona (ES)

(72) Inventors: Bartek Kunowski, Barcelona (ES); Adnane Ouahabi, Barcelona (ES)

(21) Appl. No.: 16/148,136

(22) Filed: Oct. 1, 2018

(51) Int. Cl. G06Q 10/08; G06Q 10/06

(52) U.S. Cl. CPC G06Q 10/0835; G06Q 10/0635; G06Q 10/06316; G06Q 10/0834

(57) ABSTRACT

A system and method are provided for reducing fraud in courier based transactions, while also improving courier security. An algorithm is provided that chooses specific carriers to handle cash based transactions, and pays the given carrier their salary or commission in cash every day the carrier works in order to reduce the money the carrier owes the courier company. The system that implements the algorithm maintains a record of the real time and exact cash balance held by each carrier, and establishes a minimum cash buffer for the individual carriers that acts as a cash money in reserve for the carrier to meet their needs to conduct business. Cash balances for each carrier are determined by the system tracking the approximate amount of money of the order(s) given to the carrier, and the day salary to be paid to the individual carrier.

### FIELD OF THE INVENTION

The present invention in general relates to commerce, and in particular to a system and method for managing courier based transactions.

### BACKGROUND OF THE INVENTION

Internet based commerce has made the ordering and delivery of goods via the mail, logistic and package handling companies, and courier services common place. Recently, an emphasis has been placed on same day and even quicker deliveries of items ordered over the Internet. Courier services are often contracted to handle these expedited deliveries.

A courier service employs a number of carriers who are sent to pick up an item from a store that has been ordered. Generally, the store will contract the carrier service to make the deliveries. In cases where the item is not prepaid for by the ordering customer, the carrier when receiving the order goes to the store, business, or individual to buy the product (pays in cash or by credit card) and delivers the product to the costumer and charges the costumer for the item. Once a form of payment is handed by the customer to the carrier, the item is given to the customer.

However, in some countries carriers when making deliveries charge the customer cash for the delivered item. The cashed based transaction presents a security problem for the carrier who may be robbed, since the carrier is known to carry cash. Furthermore, there is a security problem for the courier company that may be subject to acts of stealing or fraud by the carriers who are tempted to steal cash from the courier company.

Therefore, there is a need for improved transaction based security measures for companies and their carriers

### SUMMARY OF THE INVENTION

A non-transitory computer-readable medium is provided for cash management of carriers employed by a courier service, the non-transitory computer-readable medium having instructions stored thereon, that when executed on a processor, perform the steps of: compiling a stored list of the carriers; maintaining a cash balance for each of the carriers; calculating a minimum cash buffer or a cash buffer percentage; and determining the types of orders the carrier is eligible for based on the cash balance of the carrier in relation to the minimum cash buffer.

A system is provided for implementing a non-transitory computer-readable medium for cash management of carriers employed by a courier service. The system includes a set of smart phones, tablets, or portable computers, each uniquely assigned to one of the carriers in electronic data communication with a central server at the courier service, the central server having instructions stored thereon, that when executed on a processor, perform the steps of: compiling a stored list of the carriers; maintaining a cash balance for each of the carriers; calculating a cash buffer or a cash buffer percentage; and determining the types of orders the carrier is eligible for based on the calculated cash buffer.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram of a carrier building up a cash buffer to be able to handle cash orders in accordance with embodiments of the invention;

FIG. 2 is a flow diagram for assigning cash orders to a carrier in accordance with embodiments of the invention; and

FIG. 3 is a schematic diagram illustrating an overall view of communication devices, computing devices, and mediums for implementing embodiments of the invention.

### DETAILED DESCRIPTION OF THE INVENTION

The present invention has utility as an automated system and method for reducing fraud in courier based transactions, while also improving courier security. Embodiments of the invention utilize various technology platforms to manage and track carriers employed by a courier service. An algorithm is provided that chooses specific carriers to handle cash based transactions, and pays the carriers their salary, commission, or a combination of salary and commission in cash every day the carrier works in order to reduce the money the carrier owes the courier company. Inventive embodiments of the system that implement the algorithm keep a record of the real time and exact cash balance held by each carrier, and establishes a buffer for the individual carriers that acts as a cash money in reserve for the carrier to meet their needs to conduct business. Cash balances for each carriers are determined by the system tracking the approximate amount of money of the order(s) given to the carrier, and the day salary or combination of salary and commission to be paid to the individual carrier.

As used herein, a smart phone is defined as a mobile phone that performs many of the functions of a computer, Internet access, and an operating system capable of running downloaded applications and having a graphical user interface (GUI) that can optionally include a touchscreen interface.

An embodiment of the algorithm works as follows on mobile devices including a carrier smart phone, tablet, or portable computer. The carrier must use a tangible device: in the form of a smart phone, tablet, or portable computer to control the appearance of information represented on a display and specifically disclaims other means of implementing the present invention that may be construed as extending to an abstract idea of visually displaying information. A given carrier is started out with no cash in their possession and is only assigned orders that do not require cash to be paid to the store, business, or individual having the item to be picked up. The given carrier may receive cash payments for delivered orders and the carrier will start to build a cash balance. When the given carrier reaches a predetermined cash level for the cash balance that represents the minimum cash buffer for the given carrier, the given carrier will now be assigned pick up orders that may require cash payment when picking up the order from the store, business, or individual. Thus, the algorithm makes sure that the carrier is constantly recycling cash to reduce fraud and ensure the safety of the carrier.

In an embodiment when a cash order is received, a courier service assigns the order to a carrier if at least one of the following conditions is true for a carrier: automatic teller withdrawal (ATM) is allowed, total to pay in cash is zero, or the carrier's cash balance is greater than or equal to the total to pay in cash multiplied by a buffer percentage. In a specific embodiment the buffer percentage is ten percent which corresponds to a multiplier of 1.1.

The store payment method for picking up the item by the carrier is determined based on the following: the recyclable cash balance of the carrier is greater than the order (item) value times the buffer percentage, and the recyclable cash balance for the thirtieth percentile (30 percentile) of all carriers in the firm is greater than the order (item) value times the buffer percentage. In this instance the recyclable cash balance is defined as cash balance of a carrier minus the minimum cash buffer minus outstanding carrier settled earnings. If the store, business, or individual accepts cash payments from a carrier, the carrier will be directed to pay cash if the above conditions are met, and if not the carrier will not pay the store, business, or individual. In an instance where a store, business, or individual accepts payments via credit card, if the above conditions are satisfied then cash payment will be selected for the carrier to pay the store or business, if not then the carrier should pay with a card (non-cash form of payment). It is noted that if the store, business, or individual is cash only, then cash will be the default selection for the carrier. Subsequently, the carrier picks-up the order and pays for the item with the selected payment method, and delivers the item to the customer, and the customer pays cash to the carrier. At the end of the carriers work shift, the carrier cashes out and pays themselves based on the following rule. The cash out amount is the lower amount of either the cash balance minus the minimum cash buffer, or the outstanding settled earnings of the carrier.

The smartphone, tablet, or portable computing device may be configured with global positioning (GPS) capabilities to track carrier locations and proximity to stores and businesses for pickup of ordered items, and to customers to whom ordered items are to be delivered to. The smart phone, tablet, or portable computing device may have a graphical user interface (GUI) for the carrier to enter and obtain information, the capability to scan barcodes to identify delivery items, and a credit card reader to accept credit based payments. Embodiments of the invention may interface with web browsers used on the portable communication devices. A report generator may be provided that tracks the performance of the individual carriers employed by the courier service, and maintains statics on the carriers. The reports and performance data may be stored on a database that may be kept on a central server that may be offered as a service on demand in the cloud for separate courier companies, as well as on a local server belonging to the user's organization.

The inventive embodiments disclosed in the drawings are for illustrative purposes only, and are not intended to be limiting.

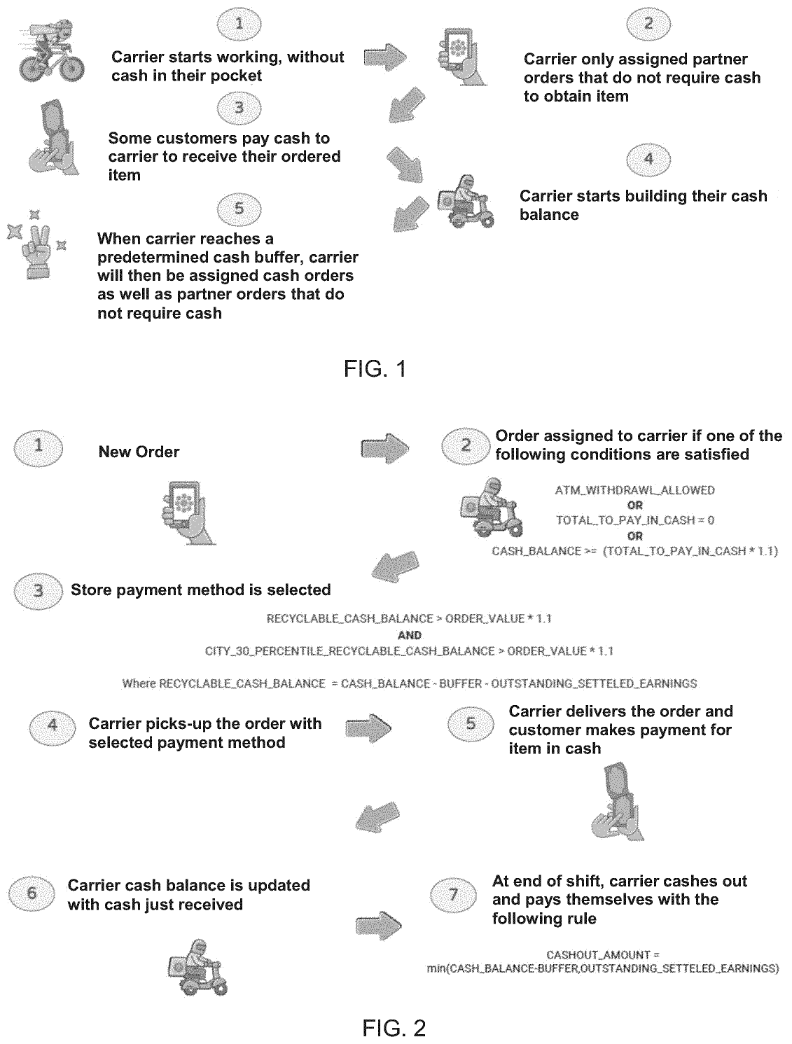

Referring now to the figures, FIG. 1 is a flow diagram of a beginning carrier building up a cash balance. Initially the carrier has no cash (Point 1), and the carrier is only assigned partner orders that do not require cash to obtain an item to be delivered (Point 2). Some customers pay cash to the carrier to receive their ordered item (Point 3) allowing the carrier to build a cash balance (Point 4). When the carrier reaches a predetermined cash level that represents a minimum cash buffer, the carrier will then be assigned cash orders as well as partner orders that do not require cash (Point 5).

FIG. 2 is a flow diagram for assigning cash orders to a carrier that has achieved a minimum level of cash. A new order is received (Point 1) and the order is assigned to the carrier (Point 2) if one of the following conditions are satisfied: automatic teller withdrawal (ATM) is allowed, total to pay in cash is zero, or the carrier cash balance is greater than or equal to the total to pay in cash multiplied by a buffer percentage. In a specific embodiment the buffer percentage is ten percent which corresponds to a multiplier of 1.1. The store payment method for picking up the item by the carrier is determined (Point 3) based on the following: the recyclable cash balance of the carrier is greater than the order (item) value times the buffer percentage, and the recyclable cash balance for the thirtieth percentile (30 percentile) of all carriers in the firm is greater than the order (item) value times the buffer percentage. In this instance the recyclable cash balance is defined as cash balance of a carrier minus the cash buffer minus outstanding carrier settled earnings. The carrier picks-up the order with selected payment method (Point 4). The carrier delivers the order and customer makes payment for item in cash (Point 5), and the cash balance of the carrier is updated based on the cash just received (Point 6). At the end of the carriers work shift, the carrier cashes out and pays themselves (Point 7) based on the following rule. The cash out amount is the lower amount of either the cash balance minus the minimum cash buffer, or the outstanding settled earnings of the carrier.

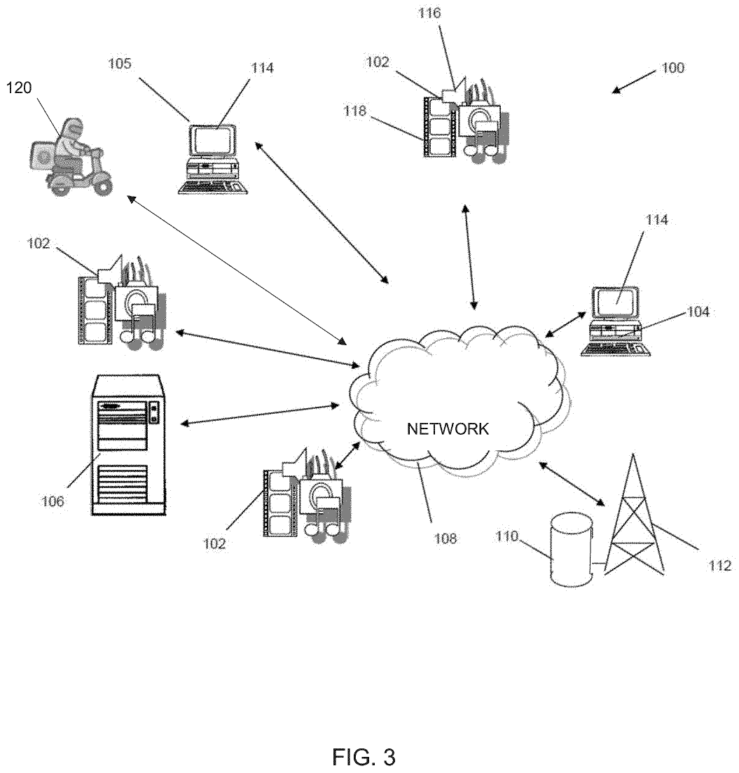

FIG. 3 is a schematic diagram illustrating an overall view of communication devices, computing devices, and mediums for implementing a system and method for monitoring and controlling cash level for individual carriers 120 in a courier system.

The system 100 includes mobile devices/remote devices illustratively including smart phones, tablets, and portable computing devices 102 and desktop computer devices 104 configured with display capabilities 114 and processors for executing instructions and commands. The smart phones 102 are smart phones or smart phones configured as tablets that are wirelessly connected to a network 108. The smart phones, tablets, and portable computing devices 102 typically have video displays 118 and audio outputs 116. The smart phones, tablets, and portable computing devices 102 and desktop computer devices 104 are optionally configured with internal storage, software, and a graphical user interface (GUI) for carrying out elements of the carrier task assignment and cash management according to embodiments of the invention. A processor may be used to execute the algorithms outline above. The network 108 is optionally any type of known network including a fixed wire line network, cable and fiber optics, over the air broadcasts, local area network (LAN), wide area network (WAN), global network (e.g., Internet), intranet, etc. with data/Internet capabilities as represented by server 106. Communication aspects of the network are represented by cellular base station 110 and antenna 112. In a preferred embodiment, the network 108 is a LAN and each remote device represented by smart phones, tablets, and portable computers 102 and desktop device 104 executes a user interface application (e.g., Web browser) to contact the server system 106 through the network 108. Alternatively, the remote devices 102 and desktop devices 104 may be implemented using a device programmed primarily for accessing network 108 such as a remote client.

The software for the carrier task assignment and cash management platform, of embodiments of the invention, may be resident on the smart phones, tablets, and portable computing devices 102 and desktop or laptop computers 104, or stored within the server 106 or cellular base station 110 for download to an end user. Server 106 may implement a cloud-based service for implementing embodiments of the platform with a multi-tenant database for storage of separate client data for each separate courier service on the platform.

The foregoing description is illustrative of particular inventive embodiments of the invention, but is not meant to be a limitation upon the practice thereof. The following claims, including all equivalents thereof, are intended to define the scope of the invention:

1. A non-transitory computer-readable medium for cash management of carriers employed by a courier service, comprising instructions stored thereon, that when executed on a processor, perform the steps of:
compiling a stored list of the carriers;
maintaining a cash balance for each of the carriers;
calculating a minimum cash buffer or a cash buffer percentage; and
determining the types of orders one of the carriers is eligible for based on the calculated minimum cash buffer and displaying an order suitable for the one of the carriers from the processor to a mobile device of the one of the carriers.

2. The non-transitory computer-readable medium of claim 1 the steps further comprising:
starting the one of the carriers with a zero cash balance and only assigning orders to the one of the carriers that does not require cash to be paid to a store, a business or an individual having an item to be picked up;
determining when one of the carriers receives cash for a delivered order;
recalculating the cash balance of the one of the carriers based on the received cash for deliveries; and
determining when the minimum cash buffer has been met.

3. The non-transitory computer-readable medium of claim 2 wherein when the minimum cash buffer has been met the steps further comprising:
allowing the carrier to be assigned pick up orders that require cash payments when picking up the order from a store, a business, or an individual.

4. The non-transitory computer-readable medium of claim 1 the steps further comprising:
assigning a cash order to the one of the carriers if at least one of the following conditions is true:
automatic teller withdrawal (ATM) is allowed for the carrier;
total to pay in cash is zero; or
the one of the carriers cash balance is greater than or equal to the total to pay in cash multiplied by the buffer percentage.

5. The non-transitory computer-readable medium of claim 1 wherein a payment method to be paid to the store, business, or individual is determined based on the following:
a recyclable cash balance of the carrier is greater than the order value times the buffer percentage, and the recyclable cash balance for the thirtieth percentile of all the carriers is greater than the order value times the buffer percentage;
wherein the recyclable cash balance is defined as cash balance of one of the carriers minus the minimum cash buffer minus outstanding carrier settled earnings;
wherein if the store, business, or individual accepts cash payments from one of the carriers, the one of the carriers will be directed to pay cash if the above conditions are met, and if not the one of the carriers will not pay the store, a business, or an individual;
wherein in an instance where the store, business, or individual accepts payments via credit card, if the above conditions are satisfied then cash payment will be selected for the carrier to pay the store or business, if not then the carrier should pay with a card (non-cash form of payment); and
wherein if the store, business, or individual is cash only, then cash will be the default selection for the carrier.

6. The non-transitory computer-readable medium of claim 1 wherein at the end of the one of the carriers work shift, the one of the carriers cashes out and pays themselves based on the following rule: cash out amount is the lower amount of either the cash balance minus the buffer, or the outstanding settled earnings of the one of the carriers.

7. The non-transitory computer-readable medium of claim 1 wherein the steps are performed with the means of a smart phone.

8. The non-transitory computer-readable medium of claim 7 wherein the smart phone is configured with global positioning (GPS) capabilities to track locations of the carriers and proximity to stores and businesses for pickup of ordered items, and to customers to whom ordered items are to be delivered.

9. The non-transitory computer-readable medium of claim 7 wherein the smart phone is configured to perform at least one of the functions of: to enter and obtain order information, the capability to scan barcodes to identify delivery items, a credit card reader to accept credit based payments, or a combination thereof.

10. The non-transitory computer-readable medium of claim 1 further comprising:
a report generator that tracks the performance of each of the carriers employed by the courier service, and maintains statistics for each of the carriers.

11. The non-transitory computer-readable medium of claim 10 wherein sets of reports and performance data obtained from the report generator are stored in a database on a central server or as a service on demand in the cloud for separate courier companies.

12. A system for implementing a non-transitory computer-readable medium for cash management of carriers employed by a courier service using smart phones, comprising:
a set of mobile devices uniquely assigned to each of the carriers in electronic communication with a central server at the courier service, the central server having instructions stored thereon, that when executed on a processor, perform the steps of:
compiling a stored list of the carriers;
maintaining a cash balance for each of the carriers;
calculating a minimum cash buffer or a cash buffer percentage; and
determining the types of orders one of the carriers is eligible for based on the calculated minimum cash buffer and displaying an order suitable for the one of the carriers from the processor to a smart phone of the one of the carriers.

13. The system of claim 12 the steps further comprising:
starting the one of the carriers with a zero cash balance and only assigning orders to the one of the carriers that does not require cash to be paid to a store, a business or an individual having an item to be picked up;
determining when one of the carriers receives cash for a delivered order;
recalculating the cash balance of the one of the carriers based on the received cash for deliveries; and
determining when the minimum cash buffer has been met.

14. The system of claim 13 wherein when the minimum cash buffer has been met the steps further comprising:
allowing the one of the carriers to be assigned pick up orders that require cash payments when picking up the order from the store, business, or individual.

15. The system of claim 12 the steps further comprising:
assigning a cash order to the one of the carriers if at least one of the following conditions is true:
automatic teller withdrawal (ATM) is allowed for the carrier;
total to pay in cash is zero; or
the carrier cash balance is greater than or equal to the total to pay in cash multiplied by the buffer percentage.

16. The system of claim 12 wherein a store payment method to be paid to a store, a business, or an individual is determined based on the following:
a recyclable cash balance of the carrier is greater than the order (item) value times the buffer percentage, and the recyclable cash balance for the thirtieth percentile (30 percentile) of all carriers in the courier firm is greater than the order (item) value times the buffer percentage;
wherein the recyclable cash balance is defined as cash balance of a carrier minus the minimum cash buffer minus outstanding carrier settled earnings;
wherein if the store, business, or individual accepts cash payments from a carrier, the carrier will be directed to pay cash if the above conditions are met, and if not the carrier will not pay the store, business, or individual;
wherein in an instance where the store, business, or individual accepts payments via credit card, if the above conditions are satisfied then cash payment will be selected for the carrier to pay the store or business, if not then the carrier should pay with a card (non-cash form of payment); and
wherein if the store, business, or individual is cash only, then cash will be the default selection for the carrier.

17. The system of claim 12 wherein at the end of the carriers work shift, the carrier cashes out and pays themselves based on the following rule: cash out amount is the lower amount of either the cash balance minus the minimum cash buffer, or the outstanding settled earnings of the carrier.

18. The system of claim 12 wherein the set of mobile devices are configured with global positioning (GPS) capabilities to track carrier locations and proximity to stores and businesses for pickup of ordered items, and to customers to whom ordered items are to be delivered to.

19. The system of claim 12 wherein the set of mobile devices are configured with a graphical user interface (GUI) for the carrier to enter and obtain information, the capability to scan barcodes to identify delivery items, and a credit card reader to accept credit based payments.

20. The system of claim 12 further comprising:
a report generator that tracks the performance of the one of the carriers employed by the courier service, and maintains statics on the carriers.
